(19) United States
(12) Patent Application Publication
(10) Pub. No.: US 2013/0167110 A1
(43) Pub. Date: Jun. 27, 2013

(54) MODELED USER INTERFACE CONTROLLERS

(71) Applicants: René Gross, Heidelberg (DE); Dirk Stumpf, Garben-Neudorf (DE); Tim Kornmann, Wiesloch (DE); Gerd M. Ritter, Heidelberg (DE)

(72) Inventors: René Gross, Heidelberg (DE); Dirk Stumpf, Garben-Neudorf (DE); Tim Kornmann, Wiesloch (DE); Gerd M. Ritter, Heidelberg (DE)

(21) Appl. No.: 13/337,645

(22) Filed: Dec. 27, 2011

(51) Int. Cl. G06F 9/44

(52) U.S. Cl. 717/105

(57) ABSTRACT

A computer-implemented system may receive and store first metadata defining a view of a user interface component, the first metadata conforming to a user interface view model, receive and store second metadata defining a controller of the user interface component, the second metadata conforming to a user interface controller model, receive and store third metadata defining data of the user interface component, the third metadata conforming to a user interface data model, and execute a framework to provide the user interface component to a client based on the first metadata, the second metadata and the third metadata.

### FIELD

Some embodiments relate to user interfaces for accessing enterprise services. More specifically, some embodiments relate to user interfaces implemented using a Model-View-Controller (MVC) or a Model-View-Presenter (MVP) paradigm.

### BACKGROUND

Software development environments offer several alternatives for the development of a software application. For example, a developer may model application elements and subsequently invoke tools to generate code or generic runtime handling to based on the modeled elements. Alternatively, the developer may directly implement the code/runtime handling in a corresponding programming language. The former alternative requires significantly less development and maintenance efforts than the latter, and provides increased quality control.

State-of-the-art user interface development environments typically conform to either the MVC or the MVP paradigm. According to these paradigms, the Model defines the data to display, the View defines how the data is displayed, and the Controller/Presenter defines how the user, the View, and the Model interact. Most development environments allow a user to model the View, and some environments also allow the user to model the Model. However, conventional development environments require the developer to completely implement the Controller/Presenter in code.

According to some conventional application platforms, a developer codes an Enhanced Controller Object to implement Controller logic. These objects may specify View behavior regarding locking, creating, changing and reading data, provide logic for responding to user input, implement model adaptations of business objects underlying the Data model, and control message handling. Coding requirements of such Enhanced Controller Objects result in large development and maintenance efforts, inflexibility, functional gaps, etc.

### BRIEF DESCRIPTION OF THE DRAWINGS

FIG. 1 is a block diagram of a design time architecture according to some embodiments.

FIG. 2 is a block diagram of a runtime architecture according to some embodiments.

FIG. 3 is a view of an interface presenting a transformation definition according to some embodiments.

FIG. 4 is a view of an interface to define a transformation according to some embodiments.

FIG. 5 is a view of an interface to bind a data field against a transformation according to some embodiments.

FIG. 6 is a block diagram of a controller implementation point framework according to some embodiments.

FIG. 7 is a block diagram of design time entities of a user interface component according to some embodiments.

FIG. 8 is a view of an interface to model a query input and output structure according to some embodiments.

FIG. 9 is a view of an interface to create a new message according to some embodiments.

FIG. 10 is a view of an interface presenting a message mapping definition according to some embodiments.

FIG. 11 is a UML diagram of a system message type group metaobject according to some embodiments.

FIG. 12 is a UML diagram of a system message mapping type metaobject according to some embodiments.

FIG. 13 is a block diagram of a computing device according to some embodiments.

### DETAILED DESCRIPTION

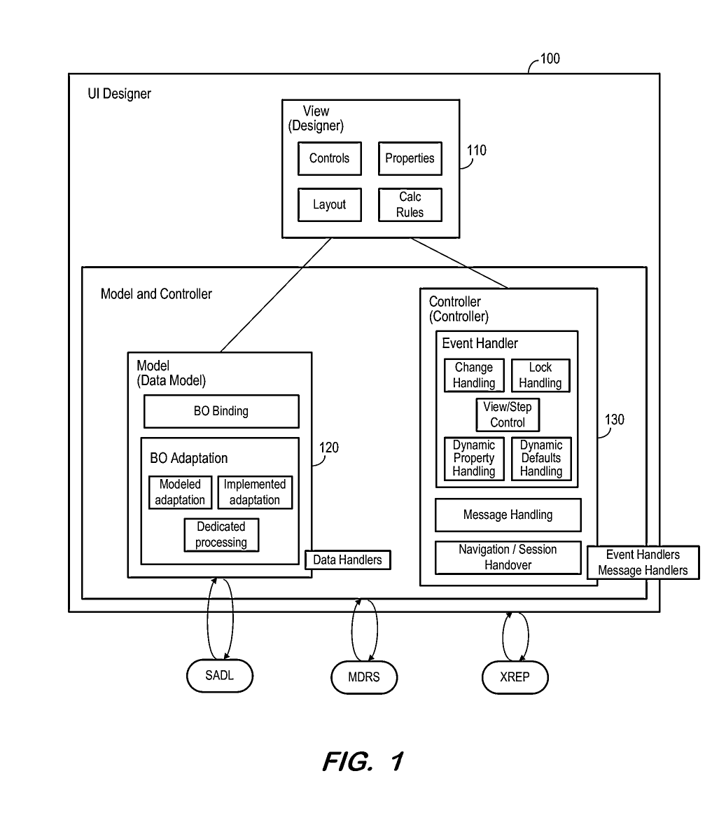

FIG. 1 is a block diagram of a logical architecture of user interface (UI) designer 100 at design time according to some embodiments. UI designer 100 includes elements for modeling a UI controller according to some embodiments. As in the case of all logical architectures described herein, actual implementations may include more or different elements arranged in any manner.

View 110 defines visible UI elements. More specifically, view 110 includes different views of a UI component, the layout of controls and views, and the controls themselves. Each UI element is associated with its own dedicated properties to control its look and feel. In addition, certain property values can be dynamically controlled via script implementations (e.g., calculation rules).

UI (data) model 120 includes model entities such as elements, structures and lists, which may be bound to UI fields/controls of a view. These model entities may also be bound to a Business Object (BO) model. The BO model defines software models (i.e., business objects) representing real-world entities involved in business transactions. For example, a business object may represent a business document such as a sales order, a purchase order, or an invoice. A business object may also represent master data objects such as a product, a business partner, or a piece of equipment. Particular documents and master data objects (e.g., SalesOrder SO4711, ACME corporation) are represented by instances of their representing business object, or business object instances. Business objects expose their data in a complex, normalized data tree which consists of nodes containing attributes, actions (executing business logic on a node) and associations to other nodes.

Business objects (BOs) are typically not designed for direct use in a UI, so an adaptation is required in order to use them in UI pattern-based end user scenarios. The present description focuses on a model-driven system to provide such adaptation.

UI model 120 may contain fields which are only bound to the view model, only bound to the BO model, or are unbound. UI model entities which are not bound to the BO model are called dedicated elements. As will be described further below, UI model entities which are bound to the BO model can be purely modeled or, in addition, can be implemented via script.

The main logic of controller 130 resides in event handlers 135. Event handler operations will be triggered by events received from view 110, model 120 or controller 130 itself. Event handler operations are provided for change handling, lock handling, view control, dynamic property handling, and dynamic default handling. Controller 130 also provides model-based navigation configuration and message mapping.

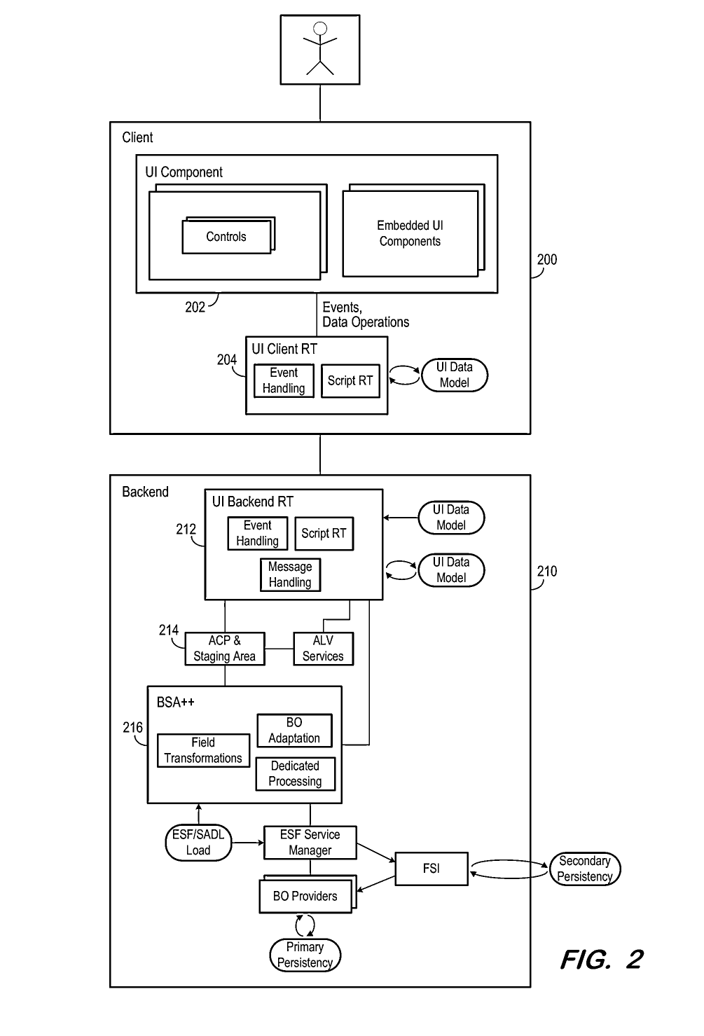

FIG. 2 is a block diagram of a runtime logical architecture according to some embodiments. The architecture may support modeled UI controllers according to some embodiments, thereby eliminating the need for coded Enhanced Controller Objects.

Client 200 executes operations associated with most elements of the View model. These elements include UI 202 with its associated views, controls and embedded components (e.g., other UIs). UI client runtime 204 is primarily responsible for connecting the UIs with backend 210. UI client runtime 204 also executes event handling which can be executed only on client 200, in which where no roundtrip to backend 210 is necessary. Such event handling includes completely modeled event handlers, as well as handlers implemented using a script language (e.g., Controller Implementation Points (CIPs, as described below). UI client runtime 202 sends a corresponding HTTP request to backend 210 in response to data changes of UI data model which are associated with a backend binding or in response to events containing operations based on backend functionality.

Backend 210 includes UI backend runtime 212 which receives the client HTTP requests, and de-serializes the requests primarily into events and data changes. Based on these events and data changes, operations on the UI data model are performed or core services on the underlying BOs are called via Application Client Proxy (ACP) 212 and Backend Service Architecture (BSA)++ runtime 216. Depending on the events and data changes involved, UI backend runtime 212 determines the corresponding operations on the data model or the BO infrastructure and executes the operations in a specific order in different phases. Service adaptation (or ALV) callbacks are offered for integration with software layers below UI backend runtime 212 in model-related cases.

UI backend runtime 212 may also execute scripts. Message mapping may also be centrally triggered centrally by UI backend runtime 212 where, based on mapping definitions as will be described below, runtime messages received from the BO layer are mapped to different ones tailored to the UI-specific needs. Model-related processing is handled by BSA++ runtime 216, including BO adaptation (e.g., nodes, queries, associations, actions), dedicated processing (for requirements of the UI model which have no relationship to the BO infrastructure), and simple field value transformations.

Regarding field transformations, the structure and node attributes of BOs do not always conform to the needs of UIs. For example, a BO node contains period attributes, but the UI may require an unlimited indicator. Field transformations are used to transform the period into the unlimited indicator.

Field transformations equip the UI data model with fields that do not have a direct counterpart within a BO node structure, but are intended to be calculated from given BO node fields. Non-exhaustive examples of such calculations, called transformation rules, include: period-to-indicator, code-to-indicator, concatenation of attribute values, time-to-duration, duration-add-to-duration, and age from date. A field transformation includes one or many inbound parameters which have either a data binding against the BO model or a constant value defined statically in the UI data model. The resulting outbound value is assigned to one or more target fields inside the UI data model. Transformations can be unidirectional or bidirectional, and used on read-only fields or on writable fields.

At design time, transformation modeling consists of creating a transformation definition in the metadata repository (MDRS) (and providing an implementation), and using this transformation definition from within the UI Designer in a concrete UI scenario. For every transformation for which no MDRS definition exists, either a new one has to be created in case it is generic, otherwise the dedicated field mechanism has to be used.

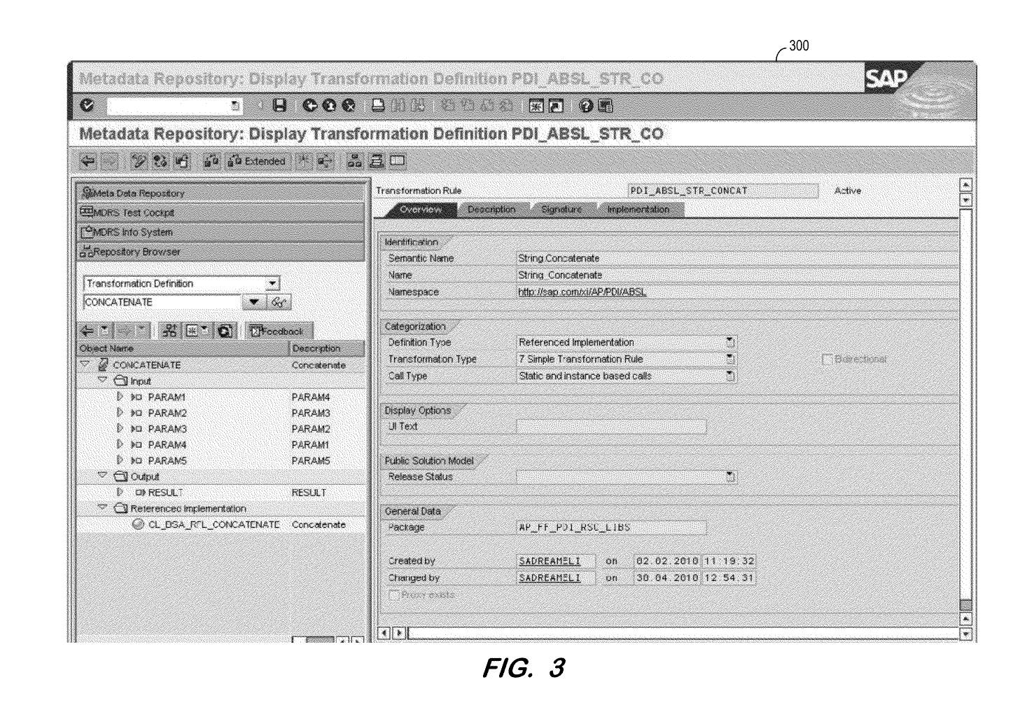

FIG. 3 depicts a user interface of a UI designer according to some embodiments. User interface 300 shows a CONCATENATE transformation as defined in the MDRS. The transformation includes five input parameters (parameters 1 and 2 are mandatory, 3 through 5 are optional) and the concatenated string as the result of the transformation. The transformation is not reversible and the result is a language-independent text. The class CL_BSA_RFL_CONCATENATE implements this transformation by implementing (like all other service adaptation reuse functions) the IF_BSA_REUSE_FUNCTION interface.

A field transformation is a separate modeling entity not only in the MDRS but also in the UI data model. This entity allows the definition of field transformation source parameters either as constant values or as bindings against BO node fields. A UI data model field is associated with its assigned field transformation and vice versa. An example xsd schema representation of the field transformation-related parts of the UI data model follows:

<xs:complexTypename =“UXFieldTransformationType”>

<xs:complexContent>

<xs:extension base=“base:ModelEntity”>

<xs:sequence>

<!-- A transformation may have a list of bound input parameters -->
<xs:element name=“TransformationInboundField”

type=“uxc: TransformationDataFieldBindType”
minOccurs=“0” maxOccurs=“unbounded”/>

<!-- A transformation may have a list of constant input parameters -->
<xs:elementname=“TransformationInboundConstant”

type =“UXTransformationInboundConstantType”
minOccurs=“0” maxOccurs=“unbounded”/>

</xs:sequence>
<xs:attributename=“name” type =“xs:string”/>
<xs:attributename=“TransformationDefinitionName”type=“xs:string”/>
<!--The Path points to the transformations target field -->
<xs:attributename=“Path” type =“xs:string”/>
<!--Enumeration of transformation types: DataField, DefaultSetParam, . . . -->
<xs:attributename=“type” type=“TransformationTypeTypes”/>

</xs:extension>

</xs:complexContent>

</xs:complexType>

TheDataFieldBindType contains the BO binding information. In case an input parameter is already part of the UI data model, it can be assigned directly in the UI Designer and the binding information is derived viaUXDataFieldType->UXBaseDataElementType->(DataFieldBindType)Bind. TheUXTransformationDataFieldBindType contains the data binding information (the same as forDataFieldBindType) plus the transformation parameter name it is mapped to:

<xs:complexTypename=“TransformationDataFieldBindType”>

<xs:complexContent>

<xs:extensionbase=“DataFieldBindType”>

<xs:attributename=“transformationParameterName”
use=“required”/>

</xs:extension>

</xs:complexContent>

</xs:complexType>

TheUXTransformationInboundConstantType contains the constant string value. The list of field transformations may be placed inside the implementation part of the UI datamodel, in parallel to the data definition, the queries, or the event handlers as shown below:

<xs:complexTypename=″UXControllerTypeImplementation″>

<xs:complexContent>

<xs:extensionbase=″base:ModelEntity″>

<xs:sequence>

<!-- Data Model-->
<xs:elementname=″DataModel″
type=″uxc:UXDataModelType″/>
<!-- Event Handlers-->
<xs:elementname=″EventHandlers″
type=″EventHandlersType″ minOccurs=″0”...
<!-- Queries-->
<xs:elementname=″Queries″ type=″QueriesType″
minOccurs=″0″...
<!-- DefaultSets-->
<xs:elementname=″DefaultSets″
type=″DefaultSetsType″ minOccurs=″0″...
...
<!-- Field Transformations-->
<xs:elementname=″FieldTransformations″ type

=″FieldTransformationsType″

minOccurs=″0″ maxOccurs=″1″/>

</xs:sequence>
<xs:attributename=″frontendOnly″ type=″xs:boolean″
use=″optional″...

</xs:extension>

</xs:complexContent>

</xs:complexType>

A data field definition specifies the field transformation to which it belongs:

<xs:complexTypename=“UXDataFieldType”>

<xs:complexContent>

<xs:extensionbase=“uxc:UXBaseDataElementType”>

<xs:sequence>

<xs:elementname=“DependentFields” type=“uxc:DataFieldDependentType”
<xs:elementname=“Codelist” type=“uxc:DataFieldCodelistType” minOccurs=“0”
<xs:elementname=“Parameters” type=“uxc:DataFieldParametersType”

```
  </xs:sequence>
  <xs:attributename=“onValueChanged” type=“xs:string” use=“optional”/>
  <xs:attributename=“type” type=“uxc:DataFieldTypes” use=“required”/> ...
  <!-- optional pointer to its beloning UXFieldTransformation-->
  <xs:attributename =“fieldTransformationID” type=“xs:string” use=“optional”
</xs:extension>
```

</xs:complexContent>

</xs:complexType>

The above may also apply to data structures (UXDataStructureType). A data structure has the same optional attribute pointing to its field transformation. Static UI model related parameters, such as ‘endOfPeriod’ will be generated into Service Adaptation Definition Language (SADL) in the form of an additional constant transformation parameter and passed at runtime accordingly (e.g., TransformationInboundConstant at theUXFieldTransformationType). The transformation provides this parameter in its interface. In one example, an optional constant parameter may be used to define the number of decimals to use for a calculation transformation.

Whether unidirectional or bidirectional, the correct data type of the transformation fields is declared in the UI Data Model. For bidirectional fields used within modify scenarios, the type information offers reasonable type-dependent value help. For unidirectional fields used within read-only scenarios, the type information may, for example, allow the definition of type-dependent formatting options. These formatting options are considered, for example, by the UI controls to format a GDT-based value coming from UI backend runtime 212 according to the user's locale, or by the ALV services in order to provide sorting according to the user's needs.

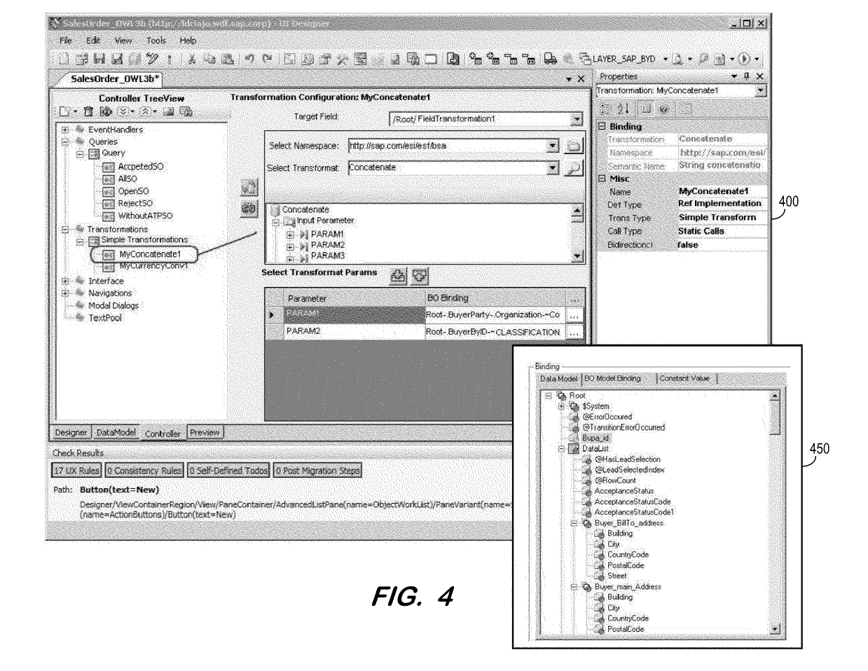

Transformations can be created inside the controller according to some embodiments, where the transformations are introduced as a new entity type. FIG. 4 illustrates interface 400 of a UI designer for defining a transformation (i.e., MyConcatenatel) and pop-up 450 for defining its bindings.

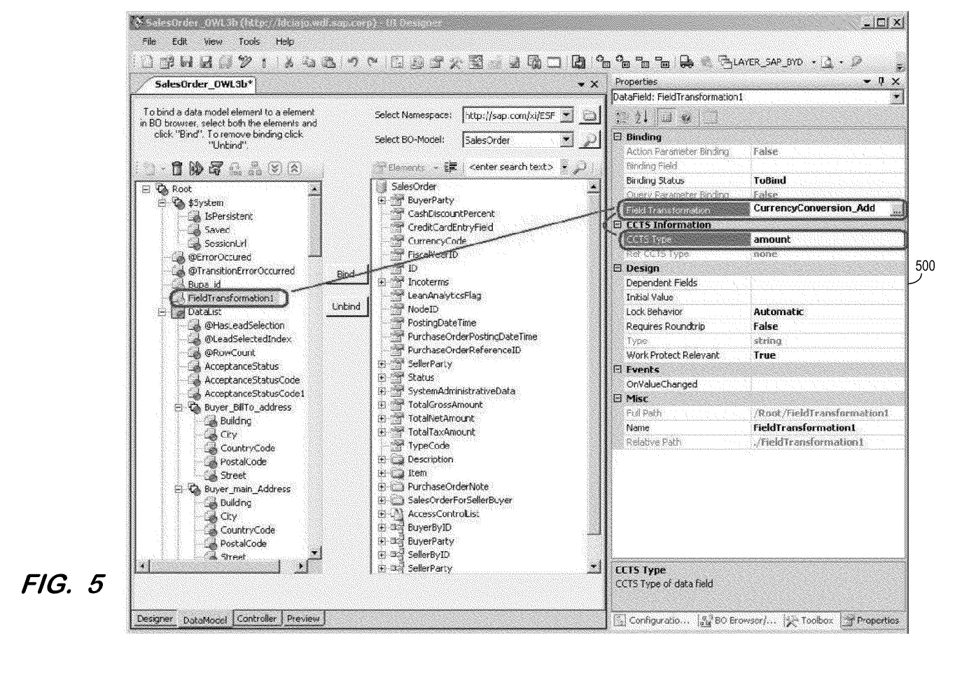

Transformation creation may also be possible when defining bindings for data fields. In this regard, FIG. 5 illustrates interface 500 for binding already existing transformations or creating new ones. According to interface 500, selection of the value help at the ‘Field Transformation’ input field results in display of the corresponding pop-up.

When creating a new field transformation, the transformation output can be assigned to a data field in the UI data model. The input for a transformation can either be a constant value, a binding against a field of a BO node structure, or an already existing data field from the UI data model. In the latter case, the binding can be derived from the UI data field.

According to some embodiments, checks are run to ensure that invalid transformations can't be configured. These checks may ensure that: all mandatory inbound parameters are bound; the source fields are of the correct type and properties (e.g., enabled, not final, read-only if used bi-directionally); and the target field is associated with its correct type as given by the outbound parameter of the transformation.

Assuming a schema as defined above, a UI component could contain a field transformation as described by the following XML snippet:

<uxc:FieldTransformationsid=“ds_fttab_01”>

<uxc:FieldTransformationid=“ds_ft_01” Path=“/Root/DataList/CompanyName2

”TransformationDefinitionName=“CONCATENATE”>

<uxc:TransformationInboundFieldid=“001” proxyName=“SalesOrder”

field=“BUYER_PARTY-.ORGANIZATION-.COMPANY_NAME”
transformationParameterName=“PARAMETER1”
esrNamespace=“http://sap.com/xi/ESF” />

<uxc:TransformationInboundFieldid=“002” proxyName=“SalesOrder”

field=“BUYER_PARTY-.ORGANIZATION-.LEGAL_FORM”
transformationParameterName=“PARAMETER2”
esrNamespace=“http://sap.com/xi/ESF” />

</uxc:FieldTransformation>

</uxc:FieldTransformations>

A data field filled by this transformation would be represented by the following snippet:

<uxc:DataField id=“F$JgZA83SawPh7NoiZi34W” name=“CompanyName2”

type=“string” initialValue=“”fieldTransformationID=“ds_ft_01”>

<base:PropertyBagid=“iZdL2EdSZKIAqpLAICHw9W”>

<base:Propertyid=“doHAVd4Y7qA3MkzaMj_HG0”name=“BINDINGSTATUS”

value=“OK” />

</base:PropertyBag>

</uxc:DataField>

The foregoing results in the concatenation of two fields, reachable from a SalesOrder BO via a cross-BO association (BuyerParty->Organization->CompanyName and LegalForm) into one field inside the UI data model (/Root/DataList/CompanyName2). Arriving at UI backend runtime 212, the field transformation is parsed and translated into a “Deployment Cache” representation. A SADL generation step will read it from there, translate it into the SADL specific syntax, and write the result into the binding attribute of this field. The syntax is: prefix=fct: (for SADL function), followed by the MDRS transformation definition name (e.g., CONCATENATE), and finally the inbound parameters in braces, separated by commas The correct order of the parameters to be passed to the transformation is given by the order in which these parameters are defined in the transformation definition. For the given example the representation would be translated as follows:

### fct:CONCATENATE(ass:BUYER_PARTY/ORGANIZATION-COMPANY_NAME, ass:BUYER_PARTY/ORGANIZATION-LEGAL_FORM)

At runtime, transformations are executed at read scenarios by acquiring the inbound data by potentially following associations to the transformation source fields, and by thereafter calling the transformation implementation class. The result is placed into the target field structure. BSA++ performs the first and third steps where no transformations are involved. By virtue of the above-described design time features, BSA++ is also able to perform the second step. Depending on the cardinalities of the transformation definition's input and output parameters, BSA++ could execute the transformation line-wise or only once per list. The core services supporting transformation fields are: Query Retrieve; Retrieve_By_Association; Retrieve_Default_Node_Values; Retrieve_Default_Action_Param; Retrieve_DefaultQuery_Param; Retrieve_Node_Elem/Action/Query_ID_Values; and Modify (i.e., in a write scenario).

For uni-directional transformations, the UI fields are read-only and overruling this property via dynamic properties is not allowed. At modify, BSA++ does not call the transformation for converting it in reverse but will keep the value provided by the UI. The BSA++ runtime passes the transformed field as part of the node structure up through ACP 214 to the UI backend runtime 214. The transformed field is then serialized and sent to UI client runtime 204.

For write scenarios using bi-directional transformations, BSA++ will take the (exactly one) transformed field and execute the associated transformation using this field as input. The resulting 0 . . . n values will be written to the bound BO fields as defined in the opposite direction for the read scenario. In the case of a write scenario (uni-directional but in the write direction) having 1 . . . n input fields for a transformation and exactly 1 output field, UI backend runtime 214 will execute the transformation.

Controller Implementation Points (CIPs) are code breakout intended to adapt core services of existing BO's according to the needs of the scenario for which the Controller is built. CIPs execute BO logic and assemble a response based on the fact that UI backend runtime 214 is based upon events and incoming data. CIPs, generally, provide adaptation of inbound parameters of UI backend operations and their resulting core services, adaptation of outbound data of UI backend operations and their resulting core services, or complete implementation of the backend operation.

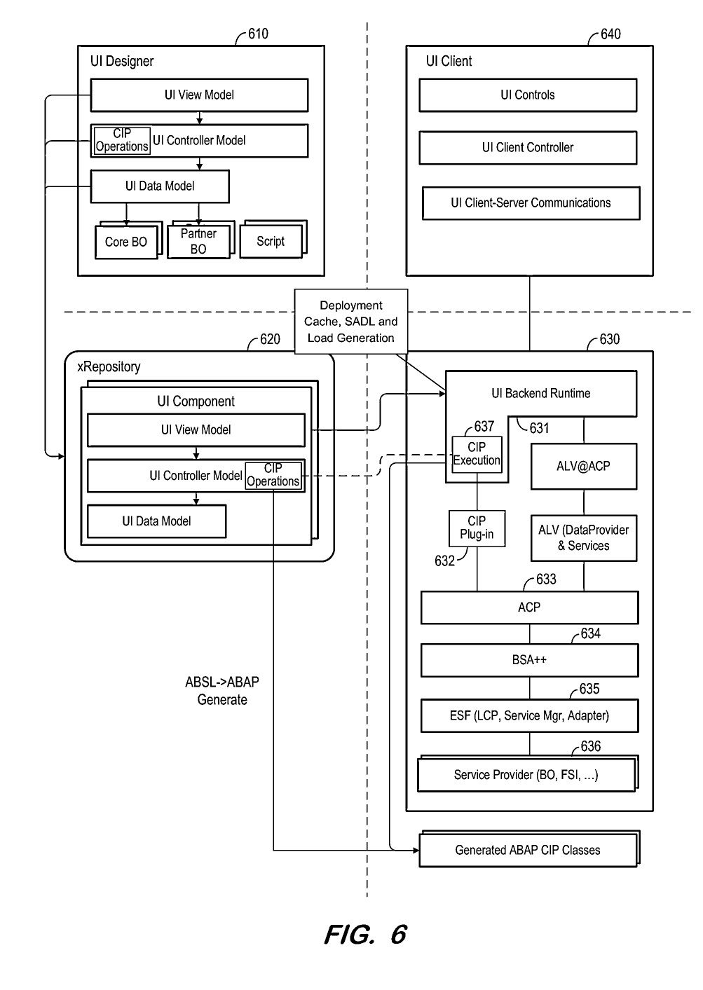

As illustrated in FIG. 6, a UI component's data model is defined inside UI designer 610 and the UI view model and the controller model are built on top of this model. The view model is simply the UI component's layout. The UI data model and controller entities are mainly bound against BO data (core or partner-created) and BO core services.

The UI component is stored in xRepository 620. When a UI component is loaded on startup, a SADL (Service Adaptation Definition Language) definition is generated alongside, with the UI component backend metadata load referring to the SADL entities. The SADL then assembles all nested BO's into a virtual BO. At runtime, the BSA++ joins all associated BO data into this virtual BO accordingly. As a result, the UI backend runtime works with such SADL BO's and is agnostic against all the nesting logic underneath.

Consequently, no UI controller logic will exist on the on BO level, but rather on the UI data model level (at design time) and on the SADL level (at runtime). Extension code written at design time will refer to the UI data model, so the execution of such extensions will happen on UI data model level. At design time, UI controller code break-outs are defined via CIPs inside the UI component controller. The CIPs will be stored in the UI component itself and will therefore be stored in XRepository 620. CIP's are modeled as backend operation event handlers similarly to, for example, the list operation ‘Add Row’. These Event Handlers can then be registered at specific UI component events.

An editor may allow equipping these CIP's with custom script code which operates on the UI data model as well as on the BOs. At UI SADL and backend load creation, the scripts are compiled into Advanced Business Application Programming language (ABAP) and placed into a UI component's controller CIP class as methods. ABAP fragments will then also be generated as methods into the controller CIP class. A script implementation mechanism will not only abstract and implement BO-based business logic but will also implicitly provide only access to a necessary, limited set of methods. The CIP classes may be created once (if not already existing) per UI model during SADL generation as soon as the first CIP has been defined.

As mentioned above, CIP design time will be handled by UI designer 610 and underlying XRepository 620. Runtime 630 will, based upon the design time content, execute the CIPs in the UI backend runtime 631 and as some plug-in 632 in ACP 633. CIP implementations may be created inside the event handler operation in the controller. The event handlers can then be registered in events which are available in the view and data model. The CIP Implementations will be stored in XRepository 620 inside the UI component definitions.

At runtime, the UI component gets loaded in backend 630 from XRep 620 and translated into the metadata load. An ABAP class is then generated which contains the ABAP code of all CIP implementations. The load will contain the event handler information describing how to handle the CIP event handler operation. When the client triggers an event handler containing a CIP Implementation, the UI backend runtime 631 will (based upon the load information) call the ABAP class interface method. The method then delegates internally to the corresponding ABAP code of the implementation.

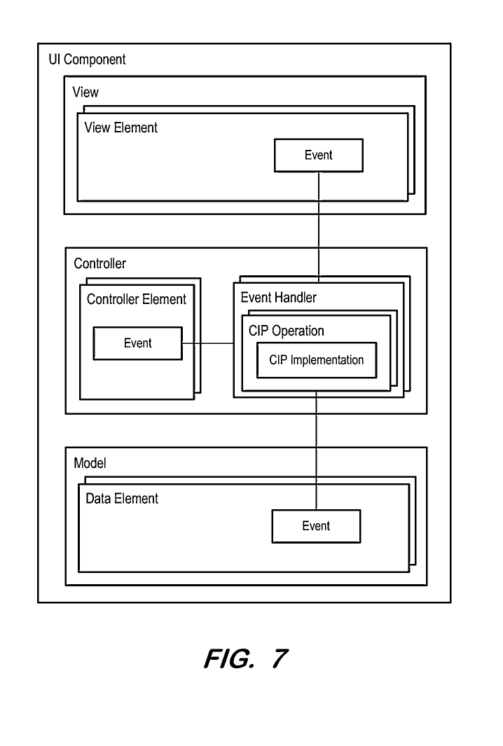

FIG. 7 is a block diagram of design time UI component entities. The different entities (Model, View and Controller) contain events. The events are triggered explicitly by users clicking on a control or implicitly by the runtime. The events are handled via event handlers in the controller. The event handlers in turn can bundle multiple event operations such as BO Action, BO Read, List operation Add Row, Fire Outport, GetValueHelp, etc. These event operations process some framework logic according to their purpose.

Controller implementation points are modeled as event operations and are therefore contained inside event handler definitions in the controller. These operations are referred to herein as CIP operations. CIP operations may be combined with other event operations. The event handler containing CIP operations can be registered inside any UI event.

The UI Designer provides a number of CIP operations wherein CIPs can be implemented, such as:

OnParameterLoad—calculation of action or query parameters. Called when action or query parameters are loaded, and is registered in OnParameterLoad event of query—or action parameter structures in data model.

OnDataLoad—handling of dedicated fields and nodes. Registered on structure or list data model entity level within the corresponding OnDataLoad event.

OnAction—handling of controller actions

OnValueHelp—handling of dynamic code lists

OnBeforeDataChange—handling of data change reaction before a MODIFY core service call

OnBOChanged—reacting on core BO data changes

OnPostProcessing—implement special message mapping

OnAssociationLoad—invent and implement associations in UI Data Model for use cases where no associations in the underlying core BOs exist

OnNavigation—implement a dynamic object-based navigation target resolution.

A CIP's interface will automatically be derived from the corresponding CIP operation. Thus, a CIP implementation of operation OnParameterLoad will have another interface as OnDataLoad. For data structures and lists placed on a Floorplan, the corresponding core service can be derived from the model. Two CIP operations are therefore sufficient to cover the core services Query, Retrieve, and Retrieve_By_Association. The two CIP operations are OnParameterLoad (for Query Parameters) and OnDataLoad.

When modeling an UI component, one or many CIP operations may be defined and implemented. The CIP coding will be stored in the UI component XML. As a result, at runtime, XRepository cache invalidation and UI Component SADL and metadata load generation will automatically be triggered when a CIP gets created, changed or deleted. At SADL and metadata load generation time, a CIP class is generated (in case it is not yet existing) having a fixed interface that covers all available CIPs.

In order to control the processing of the CIP operations according to the controller use cases (e.g., dedicated field, nodes, etc.), the UI component data model includes corresponding events on structure and list level:

OnParameterLoad—available on structure level for query and action parameter structures. Determines the corresponding action and query parameters before action-/query execution.

OnDataLoad—implement dedicated fields or nodes. Available on both structure and list levels.

OnBeforeDataChange—modify UI data before sending it to Core BO MODIFY core service. Available on both structure and list levels.

OnAssociationLoad—implement dedicated association. Available on binding path level.

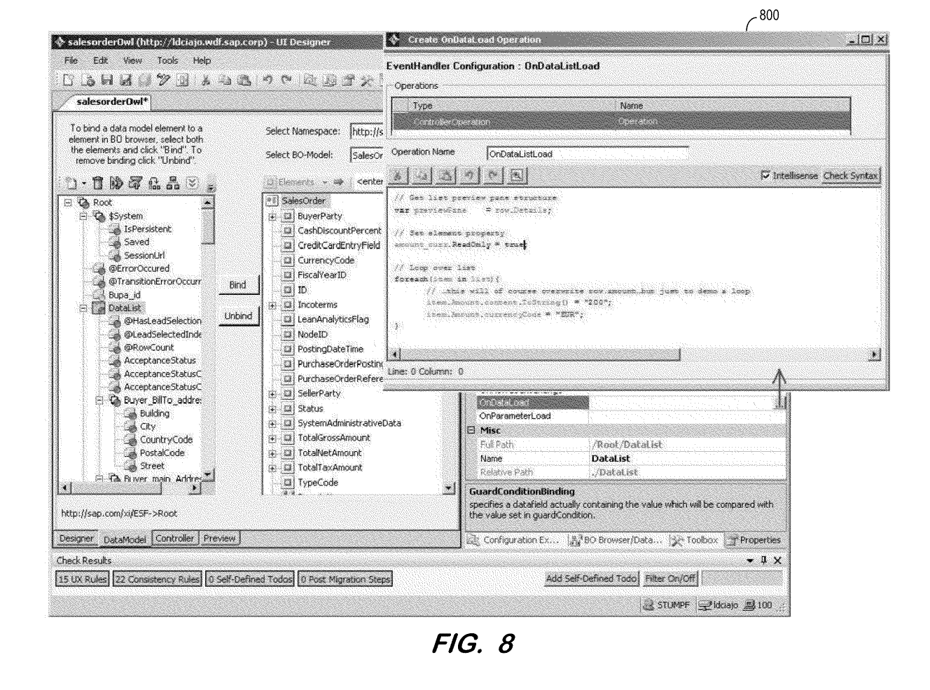

FIG. 8 depicts user interface 800 for defining the type of a CIP operation and, depending on the type, a corresponding binding. More particularly, a OnDataLoad CIP operation is created which is to be called on the backend side right after this list has been filled by its corresponding core service (e.g., query, retrieve_by_association, retrieve).

UI backend runtime 631 is responsible for syncing UI data with backend 630 and for processing UI backend events. The main entity is the Master Controller which, based upon incoming data and events, orchestrates a phase model. This phase model anticipates first executing all data changes, executing actions as well as save operations, and then reading the UI data model. A response to the client is then serialized, which includes the (changed) UI data model data along with its properties, messages, codes and event properties.

Each master controller phase executes “master commands” which translate the incoming data and events into the backend BO framework and subsequently execute core services. The Master Commands execute the core services via ACP 633. ACP 633 routes the call either directly through BSA++ runtime 634 to ESF Core (LCP->Service Manager->Adapter) 635 and finally to service provider 636.

The information about which CIP implementations are activated for which data model objects is stored inside the UI component via event handlers which contain CIP operations. These event handlers are registered either to existing UI events or to backend UI events of the UI data model. At SADL and load generation, the CIP implementations are generated into a CIP class and its CIP operations are stored in the UI metadata load in shared memory.

Event details will be stored in the load based upon the CIP operations' types and will be evaluated at runtime. In case CIPs exist, the UI backend runtime 631 registers its ACP plug-in at ACP 633 using a dedicated interface. Using this interface, UI backend runtime 631 passes a bit array to ACP 633, which determines the core service types in which the plug-in will be executed. This prevents ACP 633 from permanently calling the plug-in without any need. The bit array is passed at every session handover and is computed based upon the CIP information inside the metadata load. The bit array could take the form: 1st bit: Query; 2nd bit: RetrieveByAssociation; 3rd bit: Retrieve.

When an event handler containing a CIP operation gets executed in client 640, the client runtime will invoke the backend Master Controller. The Master Controller will access the metadata load to determine the CIP operation type. Based upon this type, the Master Controller will execute a corresponding master command in its phase. The master command calls the CIP execution which will access the metadata load to determine the CIP implementation's CIP class. It will then execute the CIP class' corresponding interface method, which then executes the CIP implementation method.

The master commands provide CIP execution 637 with context information including their phase and their data model access rights. CIP execution 637 has access to the UI data model and allows the CIP implementations to access the UI data model and write changes to the model based upon the context information. CIP execution 637 also controls the access to the core BOs. Therefore, CIP execution 637 provides a core BO access API to the CIP implementations.

As described above, CIP operation execution in ACP 633 will be done for OnLoad CIP operations. These operations can either be called explicitly from client 640 via an event handler CIP operation or, in case of a backend UI event, be executed implicitly when a SADL BO node's data gets loaded via ACP 633. In the explicit case, the Master Controller will based upon the event handler CIP operation triggering the read master command, which then executes a read on a corresponding BO Node implementation. The implementation either calls the Advanced List Viewer (ALV) based upon the node type (Structure, List, ALVList, H-List) which then calls Query/RetrieveByAssociation/Retrieve ACP core services, or the implementation calls the respective ACP core services directly (e.g., for Structure, List, and H-List). Plug-in 632 will be executed within the core services. In the second case, plug-in 632 is called implicitly when the read master command reads the UI data model based upon navigation or change notifications.

Like the master commands, plug-in 632 parameterizes and calls CIP execution 637, which has access to the backend metadata load and can, based upon the SADL BO node, determine the corresponding CIP operations and implementations. CIP execution 637 will have access to the UI data model and will allow the CIP implementations to access it and write changes to it. Plug-in 632 controls which changes are allowed and which not and will pass this information to CIP Execution 637. Based upon this, CIP execution 637 also controls the access to the core BOs. Therefore, CIP execution 637 will provide a core BO access API to the CIP implementations.

Some embodiments also provide for the handling of UI messages relating to errors, warnings or other information. Such messages are directly raised by core BOs or are triggered there but mapped/substituted to better fit to a current UI context.

A model-driven controller framework according to some embodiments utilizes a system message type group metaobject and a system message type mapping metaobject, each having their persistencies stored within the MDRS. As such, the UI Designer can read/write these entities from/to MDRS and assign message mappings to a particular UI component to be executed at an appropriate point of time.

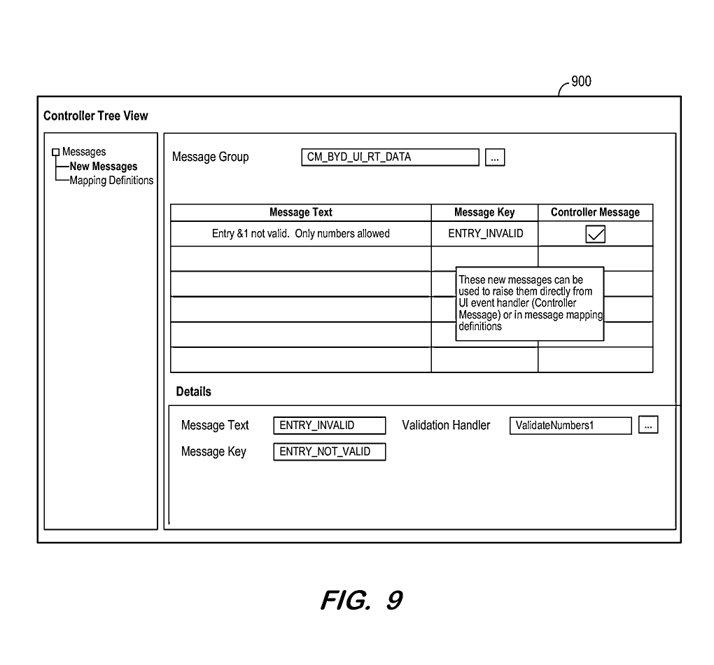

New messages can be created directly from the UI Designer as illustrated by user interface 900 of FIG. 9. These messages can be used in message mapping definitions or in scripts to directly raise UI-specific messages. The created messages are stored as instances of the system message type group and system message type mapping metaobjects in the MDRS.

The Message Group field of interface 900 corresponds to the system message type group metaobject. Interface 900 allows creation of new message mroups and changing of existing ones. Groups which are part of the package in which the UI component resides can be changed. When a new group or message (i.e., system message type metaobject) is created, it will automatically be added as part of this package. The UI Designer checks border conditions and basic validations related to the message group/messages (e.g., max. length of message text or key, allowed characters in key, etc.).

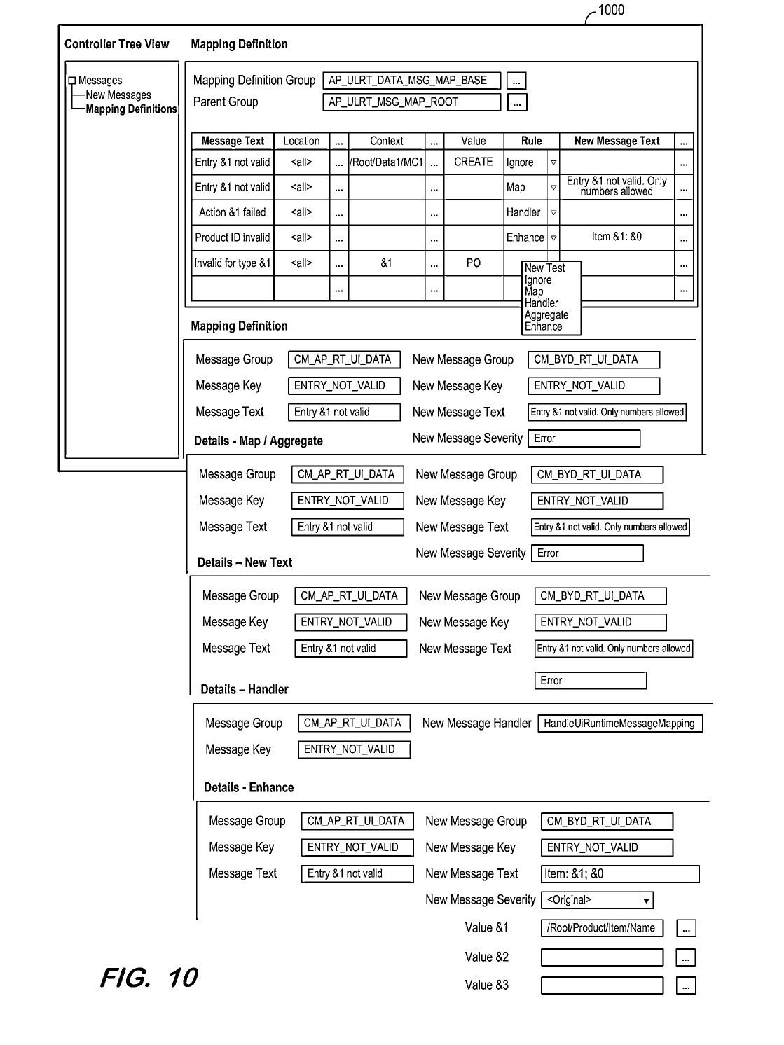

FIG. 10 illustrates interface 1000 for defining message mappings. Interface 1000 lists all messages which are potentially visible on this UI at runtime, by evaluating the registration of the system message types to BO nodes. For these messages, several mapping rules can be applied generally or based on context information. In some embodiments, one UI component can have one mapping definition group (e.g., corresponds to the mapping context in MSGM_MAPPING_CTXT and the new metaobject system message type mapping) which contains all the mapping definitions for this UI.

Such a mapping definition group is associated with a specified parent group which provides fallback mapping definitions in case a message is not found in the current group. These parent groups are defined directly in MDRS as they are not semantically related to one specific UI but are reused in several UIs or other consumers (e.g., application log). This mapping group hierarchy may include several groups above the group of the UI component (e.g., application specific groups such as HCM_COMPENSATION, HCM_GLOBAL), with one root group which is mandatory for all (BYD_COMMON).

The mapping definitions of user interface 1000 are part of one mapping group of the UI component. All the messages which may appear on this UI are listed and a mapping rule can be defined for each of them. Whether such a rule is applied during runtime can be specified via the location (e.g., corresponds to the message instance's ORIGIN_LOCATION), and context fields similarly to any UI data model field or message variable. The mapping rules are associated with corresponding detail sections of user interface 1000. As shown, mapping rules according to some embodiments include:

New Text: the original message is semantically correct but its text should be adjusted (i.e., only the message text is replaced).

Ignore: the original message does not make sense in the current UI and should not appear on UI (i.e., the message will be filtered out during runtime).

Map: the original message is replaced by another message due to semantic or structural (e.g., number/order of message variables) differences.

Handler: the mapping rule cannot be statically handled or is too complex to handle via the predefined rules so it is defined via a script handler implementation.

Aggregate: several original messages are aggregated to one message.

Enhance: the original message text is kept but enhanced by additional text and additional message variables.

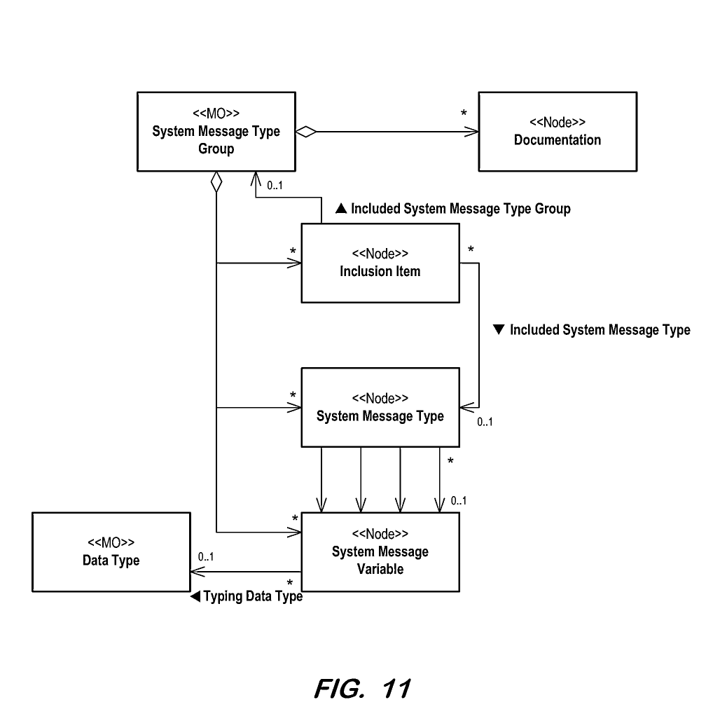

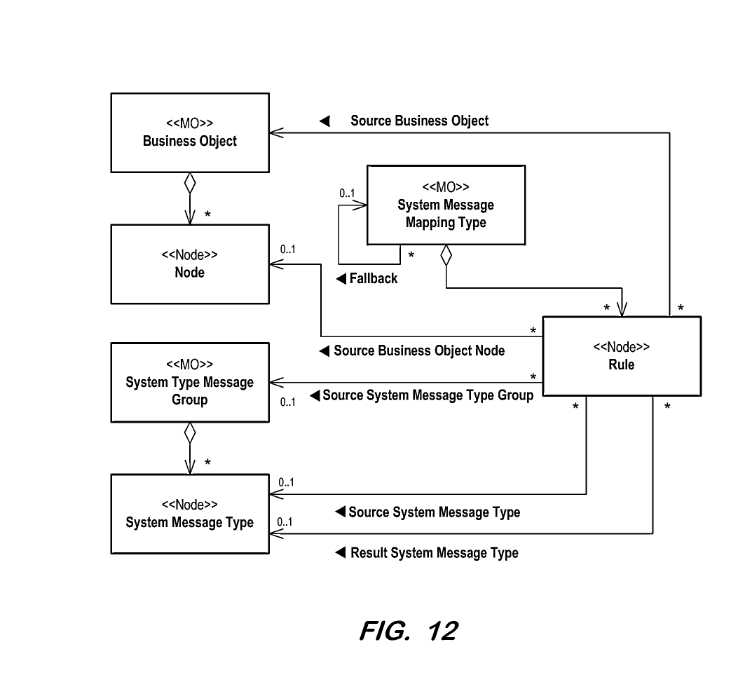

FIG. 11 is a UML diagram illustrating the above-mentioned system message type group metaobject, and FIG. 12 is a UML diagram illustrating the above-mentioned system message type mapping metaobject. The system message type mapping metaobject is a bracket around a group of mapping rules/definitions. It can be hierarchical, since it points to a fallback/parent system message type mapping. Every instance is associated with a fallback, except one centrally-defined instance. The mapping rules point to the system message type groups and system message types which are to be mapped and the ones by which they will be replaced. The rules also contain context definitions to specify the cases in which the rule is to be applied and details of the resulting message.

At runtime, messages from the underlying core BOs (and from any Enhanced Controller Objects) are collected, mapped and sent to the UI in a DO_POST_PROCESSING phase. This phase is executed at a last backend roundtrip after a user interaction (i.e., not on any backend roundtrip which may result from other reasons such as an event handler configuration).

After the call of the DO_POST_PROCESSING core service at ACP 633, UI backend runtime 631 passes all messages to client 640 and stores corresponding state message instances. In the next execution of the DO_POST_PROCESSING phase, UI backend runtime 631 performs a CHECK core service call on all CHECK_LOCATIONs of the collected state messages where a change was performed or signaled via notifications. Messages which are not delivered by the CHECK are removed and the others remain in the state message buffer.

Controller messages created/triggered in a UI event handler are checked directly by code of the validation/check handler, and UI backend runtime 631 calls the logic for validating the state message lifetime. These messages, as well as new;y-raised controller messages, are passed to the ACP DO_POST_PROCESSING core service to collect the new BO messages and perform the mapping. UI backend runtime 631 sends all messages received from ACP 633 to client 640, which removes all formerly displayed messages from the message area and displays the newly-received messages.

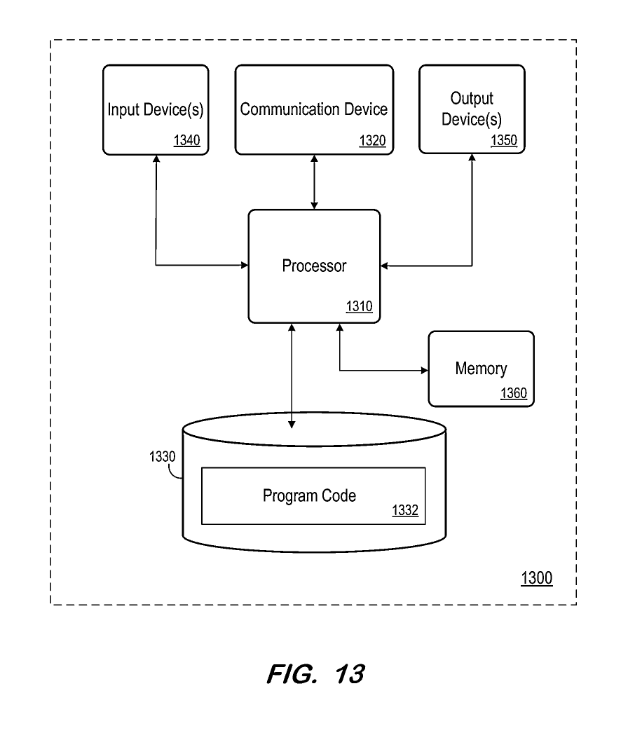

FIG. 13 is a block diagram of apparatus 1300 according to some embodiments. Apparatus 1300 may comprise a general-purpose computing apparatus and may execute program code to perform any of the functions described herein. Apparatus 1300 may comprise an implementation of client 200, backend 210, client 640 or backend 630. Apparatus 1300 may include other unshown elements according to some embodiments.

Apparatus 1300 includes processor 1310 operatively coupled to communication device 1320, data storage device 1330, one or more input devices 1340, one or more output devices 1350 and memory 1360. Communication device 1320 may facilitate communication with external devices, such as a reporting client, or a data storage device. Input device(s) 1340 may comprise, for example, a keyboard, a keypad, a mouse or other pointing device, a microphone, knob or a switch, an infra-red (IR) port, a docking station, and/or a touch screen. Input device(s) 1340 may be used, for example, to enter information into apparatus 1300. Output device(s) 1350 may comprise, for example, a display (e.g., a display screen) a speaker, and/or a printer.

Data storage device 1330 may comprise any appropriate persistent storage device, including combinations of magnetic storage devices (e.g., magnetic tape, hard disk drives and flash memory), optical storage devices, Read Only Memory (ROM) devices, etc., while memory 1360 may comprise Random Access Memory (RAM).

Program code 1332 may be executed by processor 1310 to cause apparatus 1300 to perform any one functions described herein. Embodiments are not limited to execution of these functions by a single apparatus. Data storage device 1330 may also store data and other program code for providing additional functionality and/or which are necessary for operation thereof, such as device drivers, operating system files, etc.

All processes mentioned herein may be embodied in processor-executable program code stored on one or more of non-transitory computer-readable media, such as a fixed disk, a floppy disk, a CD-ROM, a DVD-ROM, a Flash drive, and a magnetic tape. In some embodiments, hard-wired circuitry may be used in place of, or in combination with, program code for implementation of processes according to some embodiments. Embodiments are therefore not limited to any specific combination of hardware and software.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used to implement a logical architecture element described herein may include a processor to execute program code such that the computing device operates as described with respect to the element.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize other embodiments may be practiced with modifications and alterations limited only by the claims.

What is claimed is:

1. A method implemented by a computing system in response to execution of program code by a processor of the computing system, the method comprising:
receiving and storing first metadata defining a view of a user interface component, the first metadata conforming to a user interface view model;
receiving and storing second metadata defining a controller of the user interface component, the second metadata conforming to a user interface controller model;
receiving and storing third metadata defining data of the user interface component, the third metadata conforming to a user interface data model; and
executing a framework to provide the user interface component to a client based on the first metadata, the second metadata and the third metadata.

2. A method according to claim 1,
wherein the third metadata defines a binding between a field of the data and a node attribute of a business object conforming to a business object model;
wherein the second metadata defines a transformation between the node attribute and the data field, and
wherein executing the framework comprises executing the framework to transform node attribute to the data field based on the second metadata.

3. A method according to claim 2,
wherein the first metadata defines a user interface control of the user interface component;
wherein the second metadata defines an event handler associated with the user interface control, and
wherein executing the framework comprises executing the framework to detect an event associated with the user interface control and to execute the event handler in response to the detection based on the second metadata.

4. A method according to claim 3,
wherein the second metadata defines a message mapping associated with the node attribute, and
wherein executing the framework comprises executing the framework to detect a message associated with the node attribute and mapping the message based on the second metadata.

5. A method according to claim 1,
wherein the first metadata defines a user interface control of the user interface component;
wherein the second metadata defines an event handler associated with the user interface control, and
wherein executing the framework comprises executing the framework to detect an event associated with the user interface control and to execute the event handler in response to the detection based on the second metadata.

6. A method according to claim 1,
wherein the third metadata defines a binding between a field of the data and a node attribute of a business object conforming to a business object model;
wherein the second metadata defines a message mapping associated with the node attribute, and
wherein executing the framework comprises executing the framework to detect a message associated with the node attribute and mapping the message based on the second metadata.

7. A non-transitory computer-readable medium storing program code executable by a computing system to:
receive and store first metadata defining a view of a user interface component, the first metadata conforming to a user interface view model;
receive and store second metadata defining a controller of the user interface component, the second metadata conforming to a user interface controller model;
receive and store third metadata defining data of the user interface component, the third metadata conforming to a user interface data model; and
execute a framework to provide the user interface component to a client based on the first metadata, the second metadata and the third metadata.

8. A medium according to claim 7,
wherein the third metadata defines a binding between a field of the data and a node attribute of a business object conforming to a business object model;
wherein the second metadata defines a transformation between the node attribute and the data field, and
wherein execution of the framework comprises execution of the framework to transform node attribute to the data field based on the second metadata.

9. A medium according to claim 8,
wherein the first metadata defines a user interface control of the user interface component;
wherein the second metadata defines an event handler associated with the user interface control, and
wherein execution of the framework comprises execution of the framework to detect an event associated with the user interface control and to execute the event handler in response to the detection based on the second metadata.

10. A medium according to claim 9,
wherein the second metadata defines a message mapping associated with the node attribute, and
wherein execution of the framework comprises execution of the framework to detect a message associated with the node attribute and mapping the message based on the second metadata.

11. A medium according to claim 7,
wherein the first metadata defines a user interface control of the user interface component;
wherein the second metadata defines an event handler associated with the user interface control, and
wherein execution of the framework comprises execution of the framework to detect an event associated with the user interface control and to execute the event handler in response to the detection based on the second metadata.

12. A medium according to claim 7,
wherein the third metadata defines a binding between a field of the data and a node attribute of a business object conforming to a business object model;
wherein the second metadata defines a message mapping associated with the node attribute, and
wherein execution of the framework comprises execution of the framework to detect a message associated with the node attribute and mapping the message based on the second metadata.

13. A computing system comprising:
a memory storing processor-executable program code; and
a processor to execute the processor-executable program code to cause the system to:
receive and store first metadata defining a view of a user interface component, the first metadata conforming to a user interface view model;
receive and store second metadata defining a controller of the user interface component, the second metadata conforming to a user interface controller model;
receive and store third metadata defining data of the user interface component, the third metadata conforming to a user interface data model; and
execute a framework to provide the user interface component to a client based on the first metadata, the second metadata and the third metadata.

14. A medium according to claim 13,
wherein the third metadata defines a binding between a field of the data and a node attribute of a business object conforming to a business object model;
wherein the second metadata defines a transformation between the node attribute and the data field, and
wherein execution of the framework comprises execution of the framework to transform node attribute to the data field based on the second metadata.

15. A medium according to claim 14,
wherein the first metadata defines a user interface control of the user interface component;
wherein the second metadata defines an event handler associated with the user interface control, and
wherein execution of the framework comprises execution of the framework to detect an event associated with the user interface control and to execute the event handler in response to the detection based on the second metadata.

16. A medium according to claim 15,
wherein the second metadata defines a message mapping associated with the node attribute, and
wherein execution of the framework comprises execution of the framework to detect a message associated with the node attribute and mapping the message based on the second metadata.

17. A medium according to claim 13,
wherein the first metadata defines a user interface control of the user interface component;
wherein the second metadata defines an event handler associated with the user interface control, and
wherein execution of the framework comprises execution of the framework to detect an event associated with the user interface control and to execute the event handler in response to the detection based on the second metadata.

18. A medium according to claim 13,
wherein the third metadata defines a binding between a field of the data and a node attribute of a business object conforming to a business object model;
wherein the second metadata defines a message mapping associated with the node attribute, and
wherein execution of the framework comprises execution of the framework to detect a message associated with the node attribute and mapping the message based on the second metadata.
